(19) United States
(12) Patent Application Publication
(10) Pub. No.: US 2009/0189938 A1
(43) Pub. Date: Jul. 30, 2009

(54) DROPLET DISCHARGE DEVICE, DISCHARGE METHOD, METHOD FOR MANUFACTURING COLOR FILTER, AND METHOD FOR MANUFACTURING ORGANIC ELECTRO LUMINESCENT DEVICE

(75) Inventor: Kenji Kojima, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/360,288

(22) Filed: Jan. 27, 2009

(30) Foreign Application Priority Data
Jan. 28, 2008 (JP) 2008-015880

(51) Int. Cl. B41J 29/38; G02F 1/1335

(52) U.S. Cl. 347/14; 349/106

(57) ABSTRACT

A droplet discharge device includes a droplet discharge head; a plurality of carriages that have the droplet discharge head and are arranged in an array; and an arrangement changing unit changing an order of the plurality of carriages in the array. In the device, the droplet discharge device discharges a liquid body to a workpiece while the droplet discharge device scans relatively to the workpiece.

### BACKGROUND

1. Technical Field

The present invention relates to a droplet discharge device, a discharge method, a method for manufacturing a color filter, and a method for manufacturing an organic electro luminescent device. The invention especially relates to a device discharging liquid bodies with a good quality.

2. Related Art

Ink jet droplet discharge devices have been known as a device that discharges droplets to a workpiece. The droplet discharge devices include a table and a carriage. The table places the workpiece, such as a substrate, thereon and moves the workpiece in one direction. The carriage moves above the table along a guide rail provided in a direction perpendicular to a direction that the table moves. The carriage includes an ink jet head (hereinafter referred to as a droplet discharge head) that discharges and applies droplets to the workpiece.

A functional liquid is supplied from a tank to the droplet discharge head. When the functional liquid is newly added, a functional liquid existing in the tank and the functional liquid newly added have slightly different viscosities. At this time, a difference of viscosities becomes a difference of fluid resistance so as to be a difference of discharge amount during the discharge. JP-A-2006-61894 is an example of related art. It discloses a method of making consumption of the functional liquid existing in a plurality of tanks almost equal when the plurality of tanks is provided. According to the example, a plurality of carriages having a droplet discharge head is provided. Then, the carriages to discharge are selected with the droplet discharge head according to a size of the workpiece and a remaining amount of the functional liquid in the tanks so that the remaining amount of the functional liquid within each tank can be equalized.

However, since an order of the discharge head does not change, consumption of the functional liquid of each carriage may not be controlled when a pattern in which a side of the workpiece is applied with more amount of the functional liquid is used.

### SUMMARY

An advantage of the invention is to solve at least a part of the above described problems, and can be achieved as following aspects.

According to a first aspect of the invention, a droplet discharge device includes: a droplet discharge head; a plurality of carriages that have the droplet discharge head and are arranged in an array; and an arrangement changing unit changing an order of the plurality of carriages in the array. In the device, the droplet discharge device discharges a liquid body to a workpiece while the droplet discharge device scans relatively to the workpiece.

According to the droplet discharge device, the plurality of carriages arranged in the array and the arrangement changing unit that changes the order of the plurality of carriages in the array are included. When the number of nozzles of the droplet discharge head is large or a plurality of droplet discharge heads is used, a plurality of supply paths that supply the liquid body within the droplet discharge heads is provided. Then, the liquid body is supplied from the supply path that stores the liquid body to the droplet discharge head through the supply path of each carriage.

When an amount of the liquid body within the supply path is reduced, in addition to the liquid body existing within the supply path, a new liquid body with a different production history is supplied to the supply path. Then, the liquid body is discharged with the droplet discharge head so that the liquid body existing within the supply path is reduced and switched to the new liquid body. At this time, the liquid body existing within the supply path and the liquid body that newly supplied may have different viscosities. When the viscosity varies, a discharge amount of the liquid body discharged from the nozzles varies. Accordingly, the discharge amount can be easily controlled by switching from the liquid body existing in the supply path to the new liquid body almost at a same time.

When a same pattern is repeatedly discharged to the workpiece, each droplet discharge head may have different consumption of the liquid body. When a carriage of which consumption of the liquid body is large and a carriage of which a consumption of the liquid body is small are replaced by the arrangement changing unit, consumption of liquid body existing within the supply path can be controlled. Therefore, the consumption of the liquid body within the supply path of each carriage can be controlled.

In the droplet discharge device, the droplet discharge device may include an arrangement order calculation unit which provides an instruction to the arrangement changing unit to replace at least one of the carriages. In the device, the arrangement order calculation unit calculates consumption of the liquid body of each carriage so as to provide the instruction to change an order of the carriage of which consumption is different from a predetermined amount in the array.

According to the droplet discharge device, the arrangement order calculation unit calculates the consumption of each carriage. The arrangement order calculation unit provides the instruction to change the order of the carriage of which consumption is different from a predetermined amount in the array so that the arrangement changing unit changes the order of the carriages. Therefore, the consumption can be controlled so that the liquid body existing within the supply path can be consumed almost evenly.

In the droplet discharge device, the arrangement changing unit may include a retracted position of the carriage. In the device, at least one of the carriages is retracted at the retracted position while non-retracted carriages are moved in the array direction to change the order of the plurality of the carriages.

According to the droplet discharge device, only the carriage which is relevant to the changing arrangement is moved and replaced. The arrangement of the carriages can be changed with less energy compared to a method that moves all carriages.

The droplet discharge device, the arrangement changing unit may include a plurality of arrangement changing units, the arrangement changing units being respectively provided at positions to sandwich the workpiece provided in the array direction.

According to the droplet discharge device, the arrangement changing units are provided both sides of the workpiece in the direction that the carriage in the array. Then, the carriages are replaced by using positions occupied by the plurality of the arrangement changing units and a position occupied by the workpiece so as to replace a plurality of carriages at a same time. As a result, the carriages can be replaced with a high efficiency.

In the droplet discharge device, the retracted position may be positioned in a gravity acceleration direction so as to face a place in which the carriages are arranged.

According to the droplet discharge device, a position occupied by the retracted position and positions occupied by the carriages are overlapped. As a result, a device which occupies a small area can be produced.

According to a second aspect of the invention, a method for discharging a liquid body to a workpiece with a droplet discharge head provided to a plurality of carriages, the method includes: calculating consumption of the liquid body of each of the plurality of carriages; and determining to change an order of the carriage of which consumption is different from a predetermined amount in the array.

According to the discharge method, the consumption of the liquid body within the droplet discharge head provided to each carriage is calculated. The carriage of which the consumption is different from the predetermined amount is replaced. Therefore, the consumption can be controlled so that the liquid body exists within the supply path can be consumed almost evenly.

According to a third aspect of the invention, a method for manufacturing a color filter in which a liquid body is discharged to a substrate with a droplet discharge head provided to a plurality of carriages so as to form a film, the method includes; calculating consumption of the liquid body of each of the plurality of carriages and determining to change an order of the carriage of which consumption is different from a predetermined amount; and changing the order of the carriage in the array. In the method, the liquid body includes a color filter formation material.

According to the method for manufacturing the color filter, an existing liquid body and a newly added liquid body can be switched almost at a same time so that a discharge amount of the liquid body discharged when switching the existing liquid body to the newly added liquid body can be controlled. Accordingly, a film thickness formed with the color filter forming material can be formed with a high accuracy so that a hue of the light transmitted through a color filter is equalized with a high quality.

According to a fourth aspect of the invention, a method for manufacturing an organic electro luminescent (EL) device in which a liquid body is discharged to a substrate with a droplet discharge head provided to a plurality of carriages so as to form a film, the method includes; calculating consumption of the liquid body of each of the plurality of carriages and determining to change an order of the carriage of which consumption is different from a predetermined amount; and changing the order of the carriage in the array. In the method, the liquid body includes a light emitting element forming material.

According to the method for manufacturing the organic EL device, an existing liquid body and a newly added liquid body can be switched almost at a same time so that a discharge amount of the light emitting element forming material discharged when switching the existing liquid body to the newly added liquid body can be controlled. Accordingly, a film thickness of the light emitting element can be formed with a high accuracy so as to equalize the light emitting characteristics of the light emitting element with a high quality.

In the droplet discharge device, the arrangement order calculation unit provides the instruction to replace the carriage of which the consumption is larger than the predetermined amount.

According to the droplet discharge device, the carriage having a large amount of consumption and the carriage having a small amount of consumption are replaced with the arrangement order calculation unit. Therefore, the consumption can be controlled so that liquid body existing within the supply path can be consumed almost evenly.

### BRIEF DESCRIPTION OF THE DRAWINGS

The invention will be described with reference to the accompanying drawings, wherein like numbers reference like elements.

FIG. 1A is a plan view and FIG. 1B is a side view schematically showing a color filter.

FIG. 2 is a perspective view schematically showing a structure of a droplet discharge device.

FIG. 3A is a plan view schematically showing a carriage, and FIG. 3B is a side view schematically showing the carriage of FIG. 3A when it is viewed from the X direction. FIG. 3C is a schematic sectional view explaining a major structure of the droplet discharge head.

FIG. 4 is a block diagram showing an electric control of the droplet discharge device.

FIG. 5 is a flowchart showing a manufacturing process for applying a functional liquid to a substrate.

FIG. 6A is a schematic view explaining a step for discharging the functional liquid to the substrate with a droplet discharge head, and FIG. 6B is a schematic view for explaining a path that the droplet discharge head passes over the substrate. FIG. 6C is a schematic view of a distribution of consumption of each carriage.

FIGS. 7A, 7B, 7C, 7D, 7E, and 7F are schematic views explaining a method for replacing the carriages.

FIGS. 8A, 8B, 8C, 8D, 8E, and 8F are schematic views explaining the method for replacing the carriages.

FIG. 9 is a schematic view explaining a liquid drain process.

FIG. 10 is a schematic perspective view showing a droplet discharge device according to a second embodiment of the invention.

FIG. 11 is an exploded perspective view schematically showing a structure of an organic EL device according to a third aspect of the invention.

### DESCRIPTION OF EXEMPLARY EMBODIMENTS

Embodiments of the present invention will be described with reference to the accompanying drawings. The scales of members in the drawing are adequately changed so that they can be recognized.

### First Embodiment

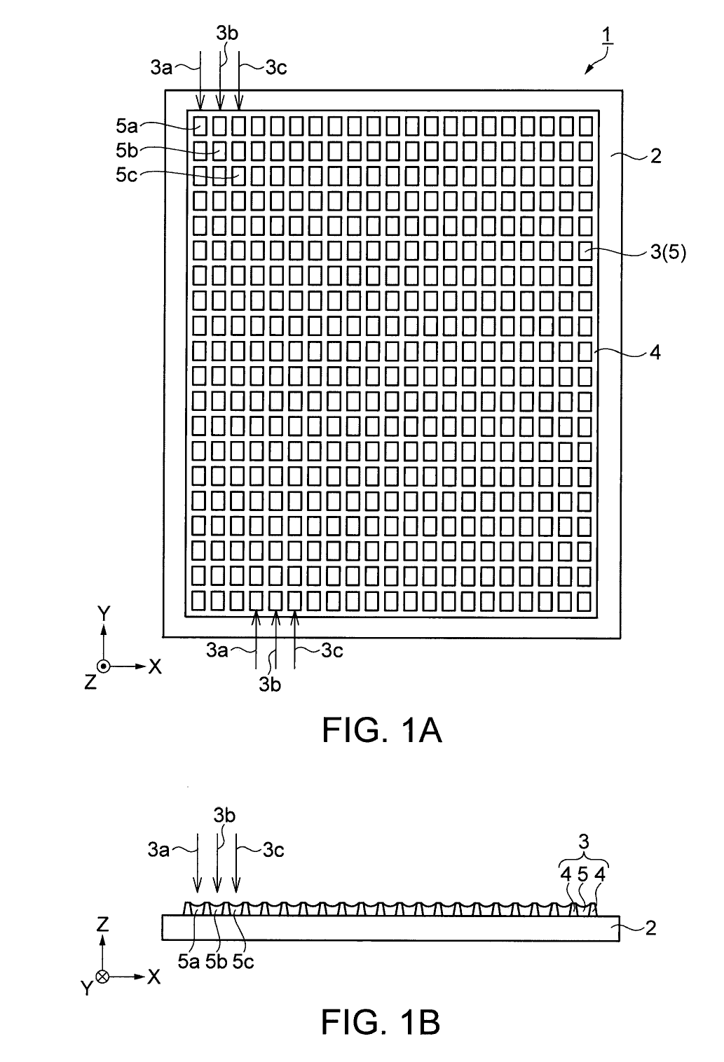

A droplet discharge device and an example of a method for manufacturing a color filter using droplets discharged from the droplet discharge device according to a first embodiment will be described with reference to FIGS. 1 to 8.

Color Filter

A color filter 1 is described with reference to FIG. 1. FIG. 1A is a plan view and FIG. 1B is a side view schematically showing the color filter. The color filter 1 is used for displays, such as liquid crystal display televisions. White light having a luminance distribution based on image signals is passed through the color filter 1 so as to form a color image. The color filter 1 is used at this time. As shown in FIGS. 1A and 1B, the color filter 1 includes a substrate 2 serving as a workpiece. The substrate 2 may be anything with optical transparency and strength of resistance to tension, such as a glass plate, a plastic plate, a plastic sheet, and the like. In the embodiment, a glass plate is used, for example. On a surface of the substrate 2, color elements 3 are formed in an array arranged in rows and columns. The color elements 3 are composed of red, blue, and green color elements 3. The color elements 3 of each color are provided in arrays per column. In FIG. 1A, a red-element-column 3a, a blue-element-column 3b, and a green-element-column 3c are provided in this order from left. Then, the order is repeated and the color elements 3 are provided in a strip shape from left to right in the drawing.

The color filter 1 includes a bank 4 which is formed in a lattice shape. A color film 5 is formed in an area partitioned in rectangular by the bank 4. A red color film 5a is formed on the color elements 3 of the red-element-column 3a, and a blue color film 5b and a green color film 5c are respectively formed on the blue-element-column 3b and the green-element-column 3c.

Droplet Discharge Device

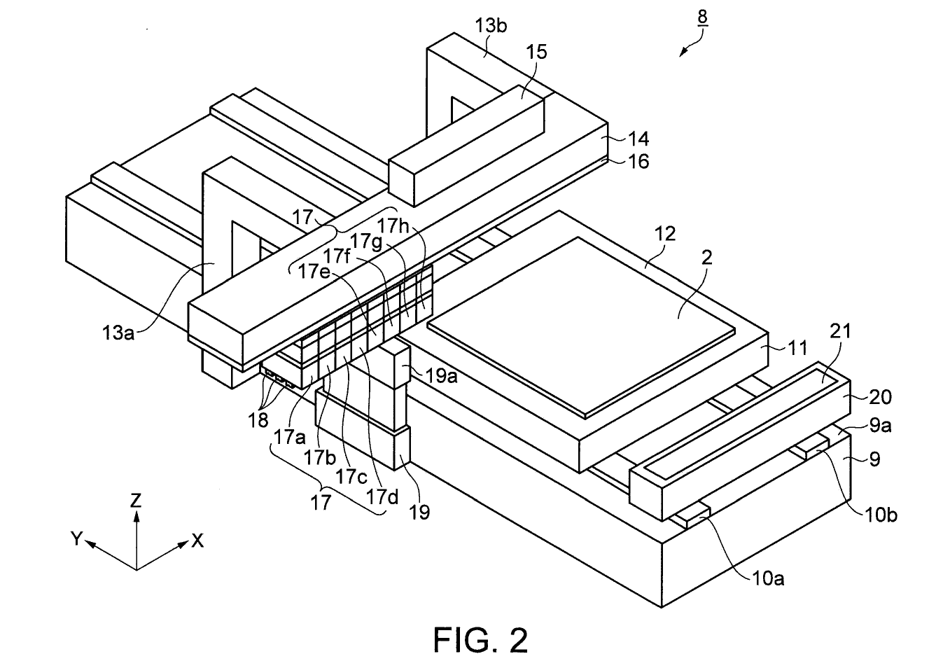

A droplet discharge device 8 that discharges and applies droplets to a workpiece will be described with reference to FIGS. 2 to 5. There are various kinds of droplet discharge devices, but a device employing an ink jet method is preferable. The ink jet method allows discharging micro droplets so that it is preferable for a fine processing.

FIG. 2 is a perspective view schematically showing a structure of the droplet discharge device. As shown in FIG. 2, the droplet discharge device 8 includes a rectangular parallelepiped base 9. A longitudinal direction of the base 9 is referred to as a Y direction, and a direction perpendicular to the Y direction is referred to as an X direction.

On an upper surface 9a of the base 9, a pair of guide rails 10a, 10b extending in the Y direction is provided in a projected manner along a whole width of the base 9. A stage 11 is attached above the base 9. The stage 11 includes a linear moving mechanism that is not shown in the drawing and corresponds to the pair of the guide rails 10a, 10b. The linear moving mechanism of the stage 11 includes a linear motor extending in the Y direction along the guide rails 10a, 10b, for example. If a driving signal corresponding to a predetermined number of steps is inputted into the linear motor, the linear motor moves forward or rearward so that the stage 11 moves forward or rearward along in the Y direction corresponding to the number of steps at a predetermined velocity. The operation makes the stage 11 moves as a scanning in the Y direction. (Hereafter, moving as a scanning referred to as moving.) A direction in which the stage 11 moves is referred to as a direction of scanning.

On an upper surface of the stage 11, a placing surface 12 is formed. The placing surface 12 includes a suction type substrate chuck mechanism that is not shown. When the substrate 2 is placed on the placing surface 12, the substrate chuck mechanism positions and fixes the substrate 2 at a predetermined position of the placing surface 12.

At both sides of the base 9 in the X direction, a pair of supports 13a, 13b is provided. A guide member 14 extending in the X direction is provided on the pair of supports 13a, 13b. On an upper side of the guide member 14, a storage tank 15 is provided. The storage tank 15 can store and supply a functional liquid to discharge. The functional liquid is a liquid body in which materials of the color film 5 are dissolved or dispersed in a solvent or a dispersion medium. The storage tank 15 includes three containers so as to form three colors of the color film 5, a red color film 5a, a blue color film 5b, and a green color film 5c. That is, the functional liquid that corresponds to the red color film 5a, the blue color film 5b, and the green color film 5c is stored in each container.

On the other hand, on a bottom side of the guide member 14, a guide rail 16 is provided in a projected manner along a whole width of the guide member 14 in the X direction. The guide rail 16 serves as an arrangement changing unit extending in the X direction. A carriage 17 is composed of eight carriages from a first carriage 17a to an eighth carriage 17h, formed in a nearly rectangular parallelepiped shape, is provided along the guide rail 16. (Hereafter the eight carriages from the first carriage 17a to the eighth carriage 17h referred to as the carriage 17.) The carriage 17 includes a same mechanism as the linear moving mechanism of the stage 11, and the mechanism can move in the X direction. On a bottom surface of each carriage 17, a droplet discharge head 18 is provided in a projected manner.

The stage 11 moves the substrate 2 in the Y direction, and the carriage 17 moves the droplet discharge head 18 in the X direction. The droplet discharge head 18 can discharge and apply the liquid body to a predetermined position of the substrate 2.

A carriage replacement device 19 which is referred to as an arrangement changing unit is provided on a side surface which is opposite to the X direction of the base 9. On an upper part of the carriage replacement device 19 includes a receiving pan 19a. A lifting mechanism that lifts and lowers the receiving pan 19a is provided in the carriage replacement device 19. The lifting mechanism includes a hydraulic cylinder and a guide rail, for example, and the hydraulic cylinder moves up and down along the guide rail. When one of the eight carriages from the first carriage 17a to the eighth carriage 17h is separated from the guide rail 16, the carriage replacement device 19 is lifted and lowered to a retracted position after the separated carriage 17 is placed thereon. Therefore, the carriage replacement device 19 separates a single carriage from the carriage 17a to the carriage 17h from an arrangement of the carriage 17 so that the separated carriage 17 to be retractable in the retracted position.

A maintenance table 20 is provided on the guide rails 10a, 10b in a direction opposite to the Y direction of the stage 11. The maintenance table 20 included the same linear moving mechanism of the stage 11, and can move along the guide rails 10a, 10b. On a top surface of the maintenance table 20, a discharge receiving part 21 is provided. The discharge receiving part 21 includes a saucer formed in a concave shape and a sponge like absorber placed on the saucer. When the liquid body is discharged with droplet discharge head 18 after the maintenance table 20 is moved to a position facing the droplet discharge head 18, the discharged liquid body is absorbed into the discharge receiving part 21.

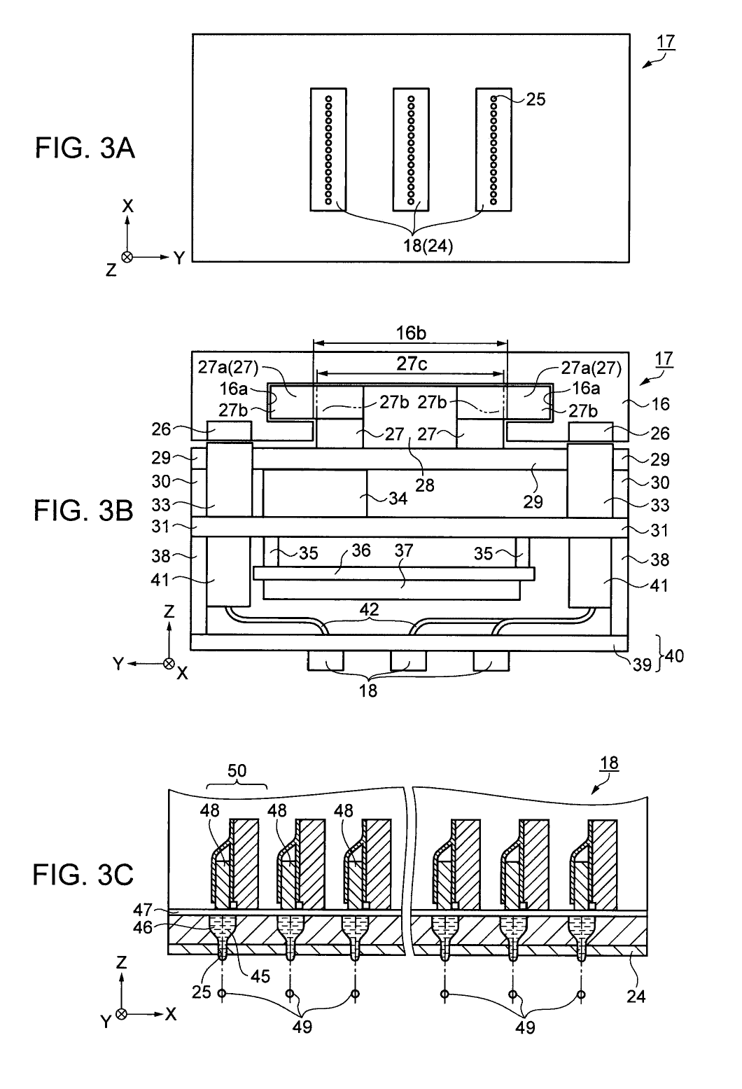

FIG. 3A is a plan view schematically showing a carriage. As shown in FIG. 3A, three droplet discharge heads 18 arranged in almost in the Y direction are provided in a single carriage from the carriage 17a to the carriage 17h. The three droplet discharge heads 18 include different colors of the functional liquids therein. The functional liquid which serves as a material of the red color film 5a is discharged from the droplet discharge head 18 located at the left side in the drawing. Similarly, the functional liquid which serves as a material of the blue color film 5b is discharged from the droplet discharge head 18 located at the center of the drawing, and the functional liquid which serves as a material of the green color film 5c is discharged from the droplet discharge head 18 located at the right side in the drawing. A nozzle plate 24 is placed on a surface of the droplet discharge head 18, and a plurality of nozzles 25 are formed on the nozzle plate 24. The number of nozzles 25 is set according to discharge patterns and a size of the substrate 2. In the embodiment, for example, an array of the nozzles 25 is formed on one piece of the nozzle plate 24, and 15 pieces of the nozzles 25 are placed on a single array.

FIG. 3B is a side view schematically showing the carriage of FIG. 3A when it is viewed from the X direction. As shown in FIG. 3B, the carriage 17 is provided to a bottom side of the guide rail 16. A T-shaped groove 16a is formed extending in the X direction at a center of the guide rail 16. Fixed magnets 26 are provided extending in the X direction on a surface facing to the carriage 17 on both sides in the Y direction. The fixed magnets 26 are formed so that north poles and south poles of the fixed magnets 26 are alternately repeated in the X direction.

A moving table 27 which is a T-shaped is provided in the groove 16a. Air is exhausted from the groove 16a towards the moving table 27 so that the air flows in a space between the groove 16a and the moving table 27. The moving table 27 serves as an air table moves along the groove 16a. The moving table 27 includes a telescopic plate 27a, a telescopic device 28, a guide rail that is not shown, and the like. The telescopic plate 27a can be stretched and contracted in the Y direction. The telescopic device 28 stretches and contracts the telescopic plate 27a. The telescopic plate 27a can move in the Y direction on the guide rail. The telescopic device 28 includes a linear moving mechanism that moves the telescopic plate 27a. The linear moving mechanism may be, for example, a screw shaft (a drive shaft) extending in the Y direction along the guide rail and a screw-type linear moving mechanism which has a ball nut that is screwed together with the screw shaft. When the telescopic plate 27a is contracted, a length of a width 27c is formed shorter than a length of a width 16b. The width 27c is a length of both ends 27b of the telescopic plate 27a in the Y direction. The width 16b is formed in thin shape in the Y direction at a lower side of the telescopic plate 27a at the groove 16a of the guide rails 16. Therefore, when the telescopic plate 27a is contracted, the moving table 27 can be pulled out from the groove 16a.

A table support plate 29 is provided at a lower side of the moving table 27. The table support plate 29 is coupled to a base plate 31 with a support part 30 therebetween. On an upper side of the base plate 31, two movable electromagnets 33 are provided to a position facing the two fixed magnets 26. A motor driving circuit 34 is provided between the two movable electromagnets 33. The movable electromagnets 33 include a plurality of coils and cores, and can be formed so that S poles and N poles of the movable electromagnets 33 are freely arranged on a surface facing the fixed magnets 26. A current flowing in the movable electromagnets 33 is controlled by the motor driving circuit 34 so as to switch positions of the S poles and the N poles of the movable electromagnets 33. A linear motor that moves in the X direction is formed by controlling an attraction and a repulsion force generated between the fixed magnets 26 and the movable electromagnets 33.

A driving circuit substrate 36 is provided on a lower side of the base plate 31 with a support part 35 therebetween. On a lower surface of the driving circuit substrate 36, a head driving circuit 37 is provided. In addition, a head mounting plate 39 is provided on the base plate 31 with a support part 38 therebetween. The droplet discharge head 18 is provided on a lower surface of the head mounting plate 39. The head mounting plate 39 on which the droplet discharge head 18 is provided serves as a head unit 40. The head driving circuit 37 and the droplet discharge head 18 are coupled with a cable that is not shown in the drawing so that a driving signal outputted from the head driving circuit 37 is inputted to the droplet discharge head 18.

On a bottom side of the base plate 31, supply devices 41 serving as a supply path are provided. The number of supply devices 41 is the same number as that of the droplet discharge head 18. The storage tank 15 and the supply devices 41 are coupled with a tube that is not shown in the drawing. The supply devices 41 and the droplet discharge head 18 are coupled with a tube 42 which serves as the supply path. The functional liquid supplied from the storage tank 15 is supplied to the droplet discharge head 18 with the supply devices 41. The supply path is composed of the tube 42, the supply devices 41, the tube between the storage tank 15 and the supply devices 41, a flow channel that the functional liquid flows within the droplet discharge head 18, and the like.

FIG. 3C is a schematic sectional view explaining a major structure of the droplet discharge head. As shown in FIG. 3C, the droplet discharge head 18 includes the nozzle plate 24. The nozzle plate 24 has the nozzles 25. A cavity 45 which serves as a pressure cell communicating with the nozzles 25 is formed at a position facing the nozzles 25 above the nozzle plate 24. A functional liquid 46 is supplied to the cavity 45 of the droplet discharge head 18 through the tube 42 and a flow channel that is not shown in the drawing. The functional liquid 46 serves as a liquid body stored in the supply devices 41.

On above the cavity 45, a vibration plate 47 and a piezoelectric element 48 are provided. The vibration plate 47 vibrates in a vertical direction (in a Z direction) to increase and decrease a volume within the cavity 45. The piezoelectric element 48 serving as a driving unit that stretches and contracts in the vertical direction to vibrate the vibration plate 47. When the droplet discharge head 18 receives a nozzle driving signal for controlling and driving the piezoelectric element 48, the piezoelectric element 48 stretches so that the vibration plate 47 increases and decreases the volume within the cavity 45, and a pressure is applied to the cavity 45. As a result, the functional liquid 46 in equal amount to a decreased volume within the cavity 45 is discharged from the nozzles 25 of the droplet discharge head 18. The discharged functional liquid 46 is referred to as a droplet 49. In the droplet discharge head 18, a droplet discharge element 50 is composed of the nozzles 25, the cavity 45, the vibration plate 47, the piezoelectric element 48, and the like. A single droplet discharge head 18 includes a plurality of droplet discharge elements 50 formed in an array.

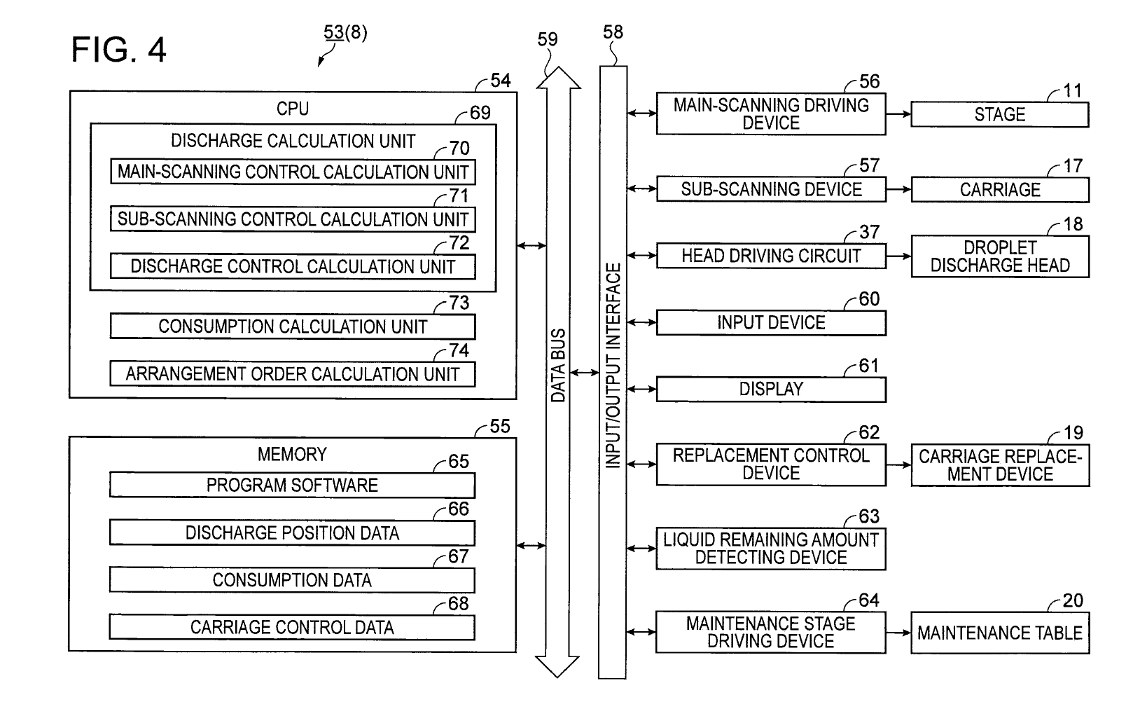

FIG. 4 is a block diagram showing an electric control of the droplet discharge device. Referring to FIG. 4, a control device 53 of the droplet discharge device 8 includes a central processing unit (CPU) 54 that executes various calculation processes as a processor, and a memory 55 that stores a various kinds of information.

A main-scanning driving device 56, a sub-scanning device 57, and the head driving circuit 37 which drives the droplet discharge head 18 are coupled to the CPU 54 through an input/output interface 58 and a data bus 59. In addition, an input device 60, a display 61, a replacement control device 62, a liquid remaining amount detecting device 63, and a maintenance stage driving device 64 are also coupled to the CPU 54 through the input/output interface 58 and the data bus 59.

The main-scanning driving device 56 controls moves of the stage 11, and the sub-scanning driving device 57 controls moves of the carriage 17. The main-scanning driving device 56 controls the moves of the stage 11, and the sub-scanning driving device 57 controls the moves of the carriage 17 so that the droplet discharge head 18 can be moved and stopped at a desired position to the substrate 2.

The input device 60 inputs various processing conditions for discharging the droplet 49. For example, the input device 60 receives coordinates to discharge the droplet 49 to the substrate 2 from an external device that is not shown in the drawing, and inputs the coordinates. The display 61 displays processing conditions and operation states. An operator executes operations with the input device 60 based on the information displayed on the display 61.

The replacement control device 62 controls the carriage replacement device 19, and controls lifting and lowering one carriage separated from the guide rail 16. Then, the replacement control device 62 drives the carriage replacement device 19 to move the separated carriage 17 between the guide rail 16 and the retracted position. The liquid remaining amount detecting device 63 is provided within the storage tank 15 to detect a remaining amount of the functional liquid 46 stored in the storage tank 15. The maintenance stage driving device 64 controls the maintenance table 20 so as to control moves of the discharge receiving part 21 between the retracted position and a place facing the droplet discharge head 18.

The memory 55 may be a concept including a semiconductor memory such as an RAM and a ROM, and an external memory device such as a hard disk and a CD-ROM. The memory 55, in terms of its function, has a memory region for storing a program software 65 in which a control procedure of operations in the droplet discharge device 8 is described. In addition, the memory 55 has a memory region for storing a discharge position data 66 that is a coordinate data of the discharge position on the substrate 2. The memory 55 also has a memory region for storing a consumption data 67 that shows the amount of the discharged functional liquid 46. The memory 55 has a memory region for storing a carriage control data 68 which is an arrangement order of the carriage 17. Additionally, the memory 55 has a memory region for storing a main-scanning moving amount of the substrate 2 moved in a main-scanning direction (the Y direction) and a sub-scanning moving amount of the carriage 17 moved in a sub-scanning direction (the X direction), a memory region serving as a work area and a temporary file for the CPU 54, and other various memory regions.

The CPU 54 controls to discharge the functional liquid 46 to be discharged as the droplet 49 to a predetermined position of the surface of the substrate 2 according to the program software 65 which is stored in the memory 55. As a specific function achieving unit, the CPU 54 includes a discharge calculation unit 69 which performs calculations for discharging the droplet 49 at the droplet discharge head 18. Particularly, the discharge calculation unit 69 includes a main-scanning control calculation unit 70 that calculates controls for moving and scanning the substrate 2 in the main-scanning direction (the Y direction) at a predetermined velocity. In addition, the discharge calculation unit 69 includes a sub-scanning control calculation unit 71 that calculates controls for moving the droplet discharge head 18 in the sub-scanning direction (the X direction) for a predetermined sub-scanning moving amount. Further, the discharge calculation unit 69 includes various kinds of function calculation units, such as a discharge control calculation unit 72 that calculates for controlling which nozzles to be operated for discharging the functional liquid among the plurality of nozzles in the droplet discharge head 18. Other than the discharge calculation unit 69, the CPU 54 also includes a consumption calculation unit 73, an arrangement order calculation unit 74, and other various kinds of function calculation units. The calculation unit 73 calculates an amount of the droplet 49 discharged from each droplet discharge head 18, and the arrangement order calculation unit 74 calculates exchange procedures of the carriage 17.

Application Method

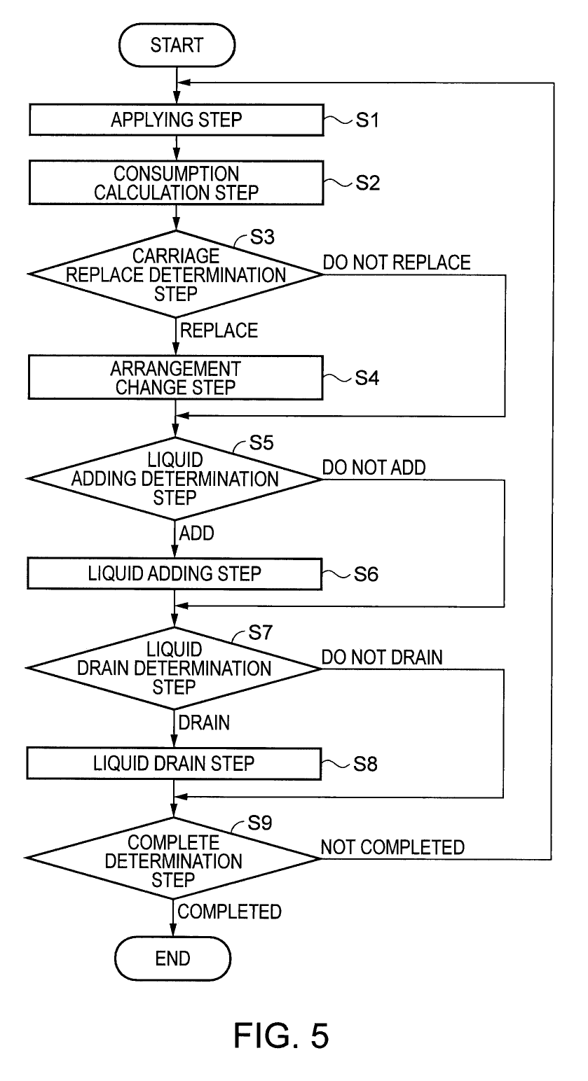

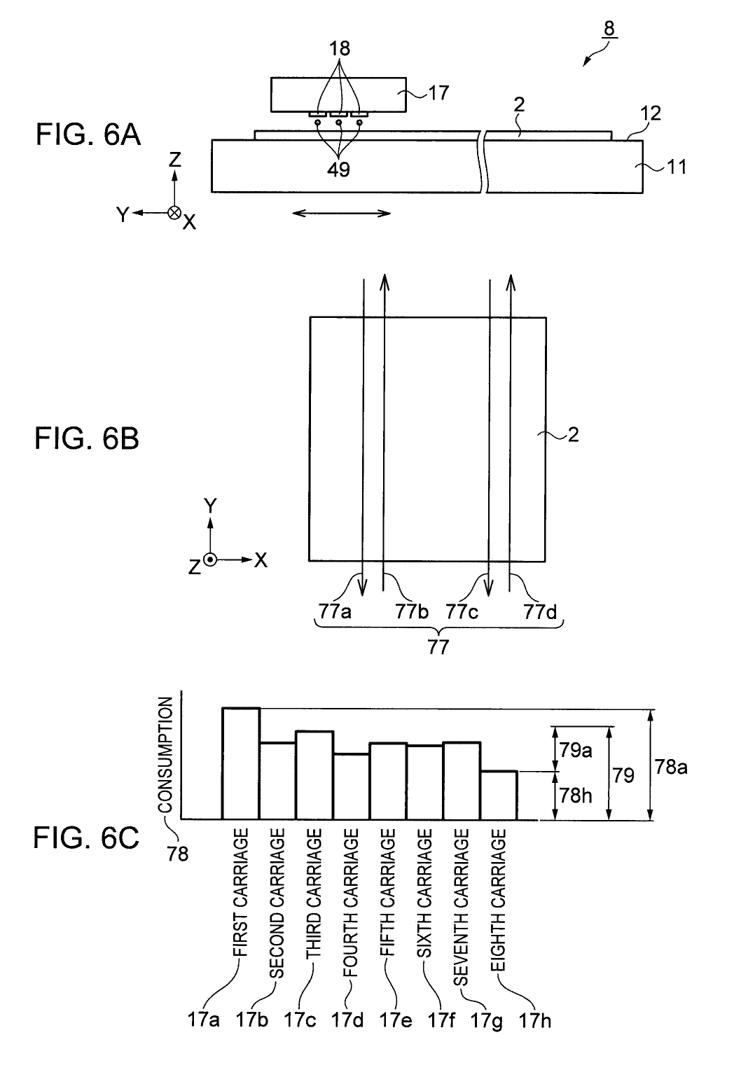

A method for applying the functional liquid 46 to the substrate 2 with the droplet discharge device 8 described above will be explained with references to FIG. 5 to 8. FIG. 5 is a flowchart showing a manufacturing process for applying the functional liquid to the substrate. FIGS. 6 to 8 are schematic views explaining a method for applying the functional liquid to the substrate.

A step S1 corresponds to an applying step in which the droplet of the functional liquid is discharged and applied to the substrate. In the step, when the droplet is discharged, the number of discharge times is counted at a same time. The step goes to a step S2. The step S2 corresponds to a consumption calculation step. In the step, a discharge amount discharged from the droplet discharge head of each carriage is calculated based on a counted result of the number of discharge times. The step goes to a step S3. The step S3 corresponds to a carriage replace determination step. In the step, a replacement of the carriage is determined referring to the discharged amount discharged from the droplet discharge head of each carriage. When the carriage is replaced, the step goes to a step in which the carriage to be replaced is chosen. When the step S3 determines not to replace the carriage, the step goes to a step S5. When the step S3 determines to replace, the step goes to a step 4. The step S4 corresponds to an arrangement change step. In the step, the carriage is replaced to change the arrangement order of the carriage. The step goes to a step S5.

The step S5 corresponds to a liquid adding determination step. In the step, an amount of the functional liquid of the storage tank is detected so as to determine whether or not to add of the functional liquid. When the step S5 determines not to add the functional liquid, the step goes to a step S7. When the step S5 determines to add, the step goes to a step 6. The step S6 corresponds to a liquid adding step. In the step, the functional liquid is added to the storage tank. The step goes to the step S7. The step S7 corresponds to a liquid drain determination step. When the functional liquids before and after adding coexist in the supply path, such as the tube, the step 7S determines whether or not to drain the functional liquid before adding. When the step S7 determines not to drain the functional liquid, the step goes to a step S9. When the step S7 determines to drain, the step goes to a step S8. The step S8 corresponds to a liquid drain step. In the step, the functional liquid which is before adding remaining in the tube is drained. The step goes to a step S9. The step S9 corresponds to a complete determination step. The step S9 determines whether or not applying the functional liquid to all of the predetermined substrate is completed. When the step S9 determines that the application is not completed, the step goes to the step S1. When the step S9 determines that the application is completed, the manufacturing process is completed. The manufacturing process for applying the functional liquid on the substrate is completed.

A method for applying the functional liquid to the substrate with the droplet discharge device will be described in detail corresponding to the steps of FIG. 5 with reference to FIG. 6 to 8. FIGS. 6A and 6B correspond to the step S1. FIG. 6A is a schematic view explaining a step for discharging the functional liquid to the substrate with the droplet discharge head, and FIG. 6B is a schematic view explaining a path that the droplet discharge head passes over the substrate. As shown in FIG. 6A, the substrate 2 is provided on the placing surface 12 of the stage 11. The bank 4 is formed on the substrate 2. After applying a photosensitive resin to the substrate 2, the bank 4 is exposed using a mask with a pattern shape of the bank 4 and developed so as to be formed. The process is formed with a known device and a known method so that the method for manufacturing process is omitted. Then, the substrate 2 is fixed to the placing surface 12 with the substrate chuck mechanism. The droplet 49 is discharged to the substrate 2 with the droplet discharge head 18 while the stage 11 moves to the Y direction. At this time, an instructing signal is outputted from the discharge calculation unit 69 with the discharge position data 66 so that the main-scanning driving device 56, the sub-scanning driving device 57, and the head driving circuit 37 are instructed to drive. The main-scanning driving device 56, the sub-scanning driving device 57, and the head driving circuit 37 respectively drive the stage 11, the carriage 17, and the droplet discharge head 18. The consumption calculation unit 73 counts the number of discharge times that each droplet discharge head 18 discharges.

FIG. 6B shows an example that a single substrate 2 is applied with the functional liquid following an applying path 77 in which the droplet discharge head 18 reciprocates twice over the stage 11. The number of reciprocations is determined by a width of the substrate 2 and a width that the droplet discharge head 18 allows applying the functional liquid in a single time. It is desirable to set an appropriate number of reciprocations. In a first forward path 77a, the droplet discharge head 18 discharges the droplet with utilizing all of the nozzles 25. Then, positions that are not applied with the functional liquid in the first forward path 77a are applied in a first backward path 77b. That is, in the arrangement of the carriage 17 having the droplet discharge head 18 in FIG. 3A, spaces between the droplet discharge heads 18 arranged in the X direction can not be applied with the functional liquid in the first forward path 77a since the nozzles 25 are not provided. The spaces are applied with the functional liquid in the first backward path 77b. The droplet discharge head 18 discharges the droplets in a second forward path 77c and a second backward path 77d similarly. A part of the droplet discharge head 18 of the eighth carriage 17h may be positioned in the X direction from the substrate 2. At this time, the discharged amount of the functional liquid 46 of the eighth carriage 17h becomes smaller than other droplet discharge heads 18. The consumption calculation unit 73 calculates the consumption of each droplet discharge heads 18 so as to store in the memory 55 as the consumption data 67.

FIG. 6C corresponds to the steps S2 and S3 showing a distribution of the consumption per carriage. In the step S2, the arrangement order calculation unit 74 tally the functional liquids 46 discharged from the droplet discharge head 18 of each carriage from the first carriage 17a to the eighth carriage 17h so as to calculate the consumption of the functional liquids 46 of each carriage from the first carriage 17a to the eighth carriage 17h. In FIG. 6C, a vertical axis shows a consumption 78 of the functional liquid 48 discharged from each droplet discharge head 18, and a horizontal axis shows the carriage 17. As shown in the drawing, the first carriage 17a has the largest amount of the consumption 78, and the eighth carriage 17h has the smallest amount of the consumption 78.

In the step S3, a difference of a predetermined amount 79a is added to a consumption 78h of the eighth carriage 17h which has the smallest consumption 78 so as to set a comparison determination amount 79 as a requirement. Then, the consumption 78 of the consumption from the first carriage 17a to a seventh carriage 17g is compared to the comparison determination amount 79. A consumption 78a of the first carriage 17a is larger than the comparison determination amount 79 so that the arrangement order calculation unit 74 determines to replace the arrangement order of the first carriage 17a with the eighth carriage 17h. Then, for the carriage 17 which has the second smallest consumption 78, the arrangement order calculation unit 74 determines whether or not to change the arrangement in a same way. Sequentially, for the carriage 17 which has the small consumption 78, the arrangement order calculation unit 74 determines whether or not to change the arrangement order in the same way.

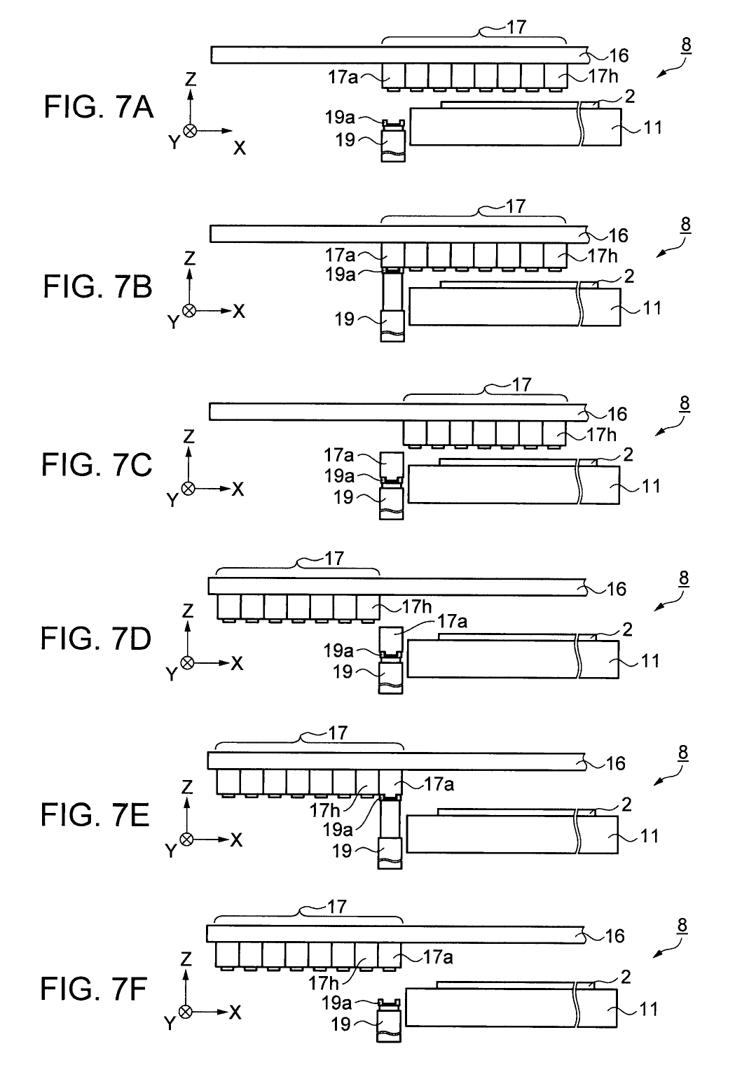

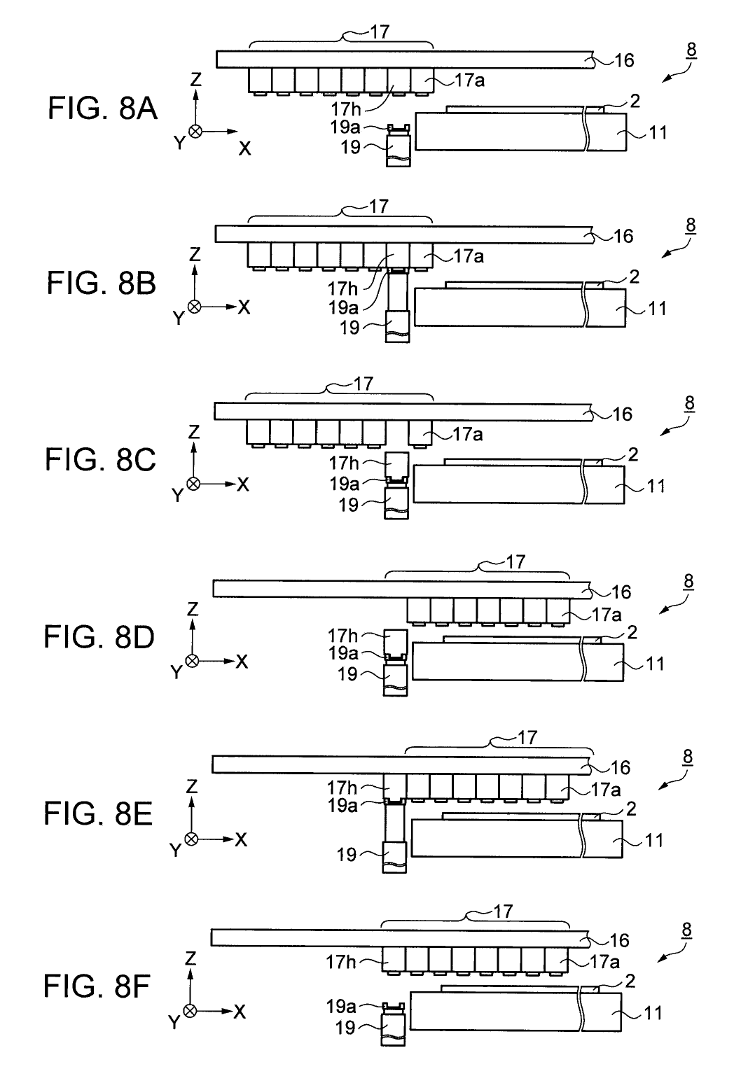

FIGS. 7A, 7B, 7C, 7D, 7E, 7F, 8A, 8B, 8C, 8D, 8E and 8F correspond to the step S4, and are schematic views explaining a method for replacing the carriages. An example of replacing the first carriage 17a with the eighth carriage 17h is shown. As shown in FIG. 7A, the first carriage 17a is moved along the guide rail 16 to a position facing the carriage replacement device 19. As shown in FIG. 7B, the carriage replacement device 19 lifts the receiving pan 19a so as to contact the first carriage 17a. The telescopic device 28 of the first carriage 17a is driven to contract the telescopic plate 27a so that the first carriage 17a can be separated from the guide rail 16. At this time, the receiving pan 19a stays under the first carriage 17a so as to receive the first carriage 17a.

As shown in FIG. 7C, the carriage replacement device 19 lowers the receiving pan 19a on which the first carriage 17a is placed. Subsequently, as shown in FIG. 7D, the carriage 17 provided on the guide rail 16 is moved to an opposite direction of the X direction. The carriages 17 are positioned at an opposite side of the X direction with respect to the carriage replacement device 19. As shown in FIG. 7E, the carriage replacement device 19 lifts the receiving pan 19a on which the first carriage 17a is placed. The receiving pan 19a is lifted with the carriage replacement device 19 so that the first carriage 17a can contact the guide rail 16. The telescopic device 28 of the first carriage 17a is driven to stretch the telescopic plate 27a so that the first carriage 17a is provided on the guide rail 16. As shown in FIG. 7F, the carriage replacement device 19 lowers the receiving pan 19a.

As shown in FIG. 8A, the eighth carriage 17h is moved along the guide rail 16 to a position facing the carriage replacement device 19. As shown in FIG. 8B, the carriage replacement device 19 lifts the receiving pan 19a so as to contact the eighth carriage 17h. Then, the telescopic device 28 of the eighth carriage 17h is driven to contract the telescopic plate 27a so that the eighth carriage 17h can be separated from the guide rail 16. At this time, the receiving pan 19a stays under the eighth carriage 17h so as to receive the eighth carriage 17h.

As shown in FIG. 8C, the carriage replacement device 19 lowers the receiving pan 19a on which the eighth carriage 17h is placed. As shown in FIG. 8D, the carriage 17 provided on the guide rail 16 is moved to the X direction. Then, the carriage 17 is positioned in the X direction with respect to the carriage replacement device 19. As shown in FIG. 8E, the carriage replacement device 19 lifts the receiving pan 19a on which the eighth carriage 17h is placed. The receiving pan 19a is lifted with the carriage replacement device 19 to a position that the eighth carriage 17h contacts the guide rail 16. The telescopic device 28 of the eighth carriage 17h is driven to stretch the telescopic plate 27a so as to provide the eighth carriage 17h on the guide rail 16. As shown in FIG. 8F, the carriage replacement device 19 lowers the receiving pan 19a. Consequently, the replacement of the first carriage 17a with the eighth carriage 17h is completed.

In the step S5, the CPU 54 determines whether or not to add the functional liquid 46 with a liquid remaining amount date outputted from the liquid remaining amount detecting device 63 provided in the storage tank 15. At this time, the CPU 54 compares the liquid remaining amount date to a predetermined amount set in advance. When the liquid remaining amount is smaller than the predetermined amount, the step S5 determines to add the functional liquid 46. Then, in the step S6, the CPU 54 displays a message on the display 61. The message requests to add the functional liquid 46. The operator sees the message so as to add the functional liquid 46 to the storage tank 15.

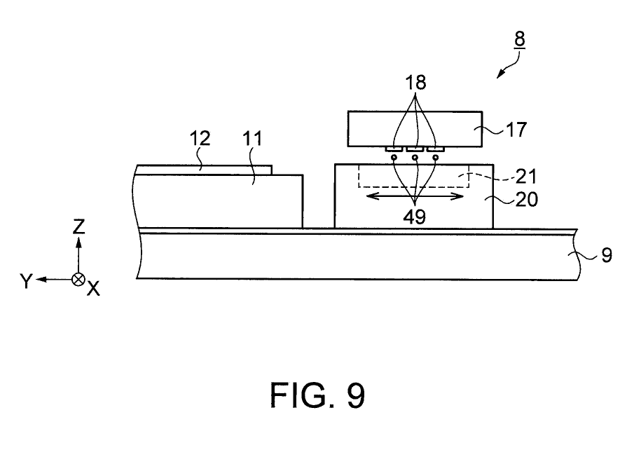

In the step S7, after the functional liquid 46 is added to the storage tank 15, the CPU 54 calculates the consumed functional liquid 46 so as to compute the consumption. When the consumption is larger than the predetermined amount, draining the functional liquid 46 is determined. FIG. 9 corresponds to the step S8, and is a schematic view explaining a liquid drain process. As shown in FIG. 9, the maintenance table 20 is moved to a position facing the droplet discharge head 18. Then, the droplet 49 is discharged from the droplet discharge head 18 to the discharge receiving part 21 so that the functional liquid 46 which is before adding is drained. The droplet 49 is discharged until the functional liquid 46 added therein starts to be discharged.

The step S9 corresponds to the end determination step. The step is completed when the functional liquid 46 is applied to all of the predetermined substrate 2. By performing the above steps, the process for applying the functional liquid 46 to the substrate 2 is completed.

According to the embodiment described above, the following advantageous effects are provided. According to the embodiment, the carriage replacement device 19 replaces the first carriage 17a of the droplet discharge head 18 with the eighth carriage 17a of the droplet discharge head 18. The first carriage 17a has the largest consumption of the functional liquid 46, and the eighth carriage 17h has the smallest consumption of the functional liquid 46. Then, after the functional liquid 46 is added to the storage tank 15, the functional liquid 46 is discharged to the substrate 2 so that the consumption of the functional liquid 46 remains in each supply path can be controlled. Therefore, the consumption of the functional liquid 46 within the supply path of each carriage from the carriage 17a to the carriage 17h can be controlled.

According to the embodiment, the arrangement order calculation unit 74 calculates the consumption of each carriage from the carriage 17a to the carriage 17h. Then, the arrangement order calculation unit 74 instructs to replace one of the carriages from the first carriage 17a to the eighth carriage 17h which has the largest consumption with one of the carriages from the first carriage 17a to the eighth carriage 17h which has the smallest consumption so that the carriage replacement device 19 replaces the carriages. Therefore, the consumption can be controlled so that the functional liquid 46 within the supply path can be consumed almost evenly.

According to the embodiment, the carriage 17 moves in the direction that the carriage 17 is arranged. Then, only at least one of the carriages from the first carriage 17a to the eighth carriage 17h which is relevant to the changing arrangement of the carriage 17 is moved and replaced. For example, when the first carriage 17a is replaced with a second carriage 17b, the first carriage 17a is lowered with the carriage replacement device 19. After the second carriage 17b is moved along the guide rail 16, the first carriage 17a is lifted so as to be returned to the arrangement of the carriage 17. Therefore, the first carriage 17a can be replaced with the second carriage 17b without moving the carriages from a carriage 17c to the carriage 17h. As a result, the arrangement of the carriages 17 can be changed with less energy compared to a method that moves all carriages.

According to the embodiment, at least one of the carriages from the first carriage 17a to the eighth carriage 17h is replaced using a position of the guide rail 16 and a position of the carriage replacement device 19. Therefore, the carriages can be replaced in a smaller location than moving all carriages from the carriage 17a to the carriage 17h to a replace location. As a result, a device which occupies a small area can be produced.

According to the embodiment, the functional liquid 46 which is before a new functional liquid 46 is added to the storage tank 15 and existing therein and the functional liquid 46 which is newly added are switched almost at the same time at the droplet discharge head 18 so that the amount of the functional liquid 46 discharged when the functional liquids 46 are switched can be controlled. Therefore, a film thickness formed with the functional liquid 46 can be formed with a high accuracy so that a hue of the light transmitted through the color filter 1 is equalized with a high quality.

### Second Embodiment

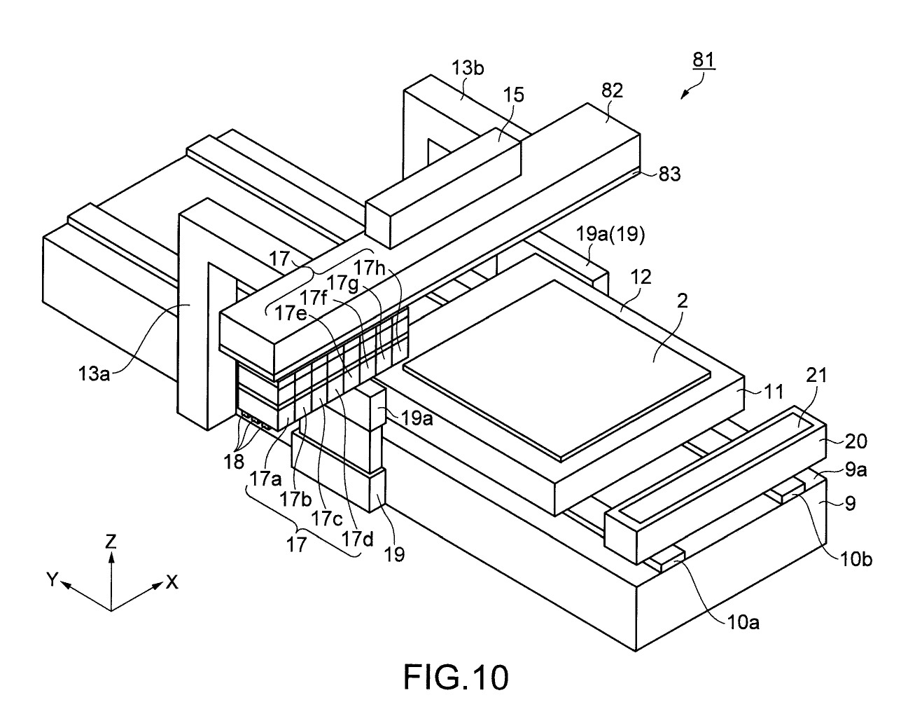

A characteristic example of the droplet discharge device will be explained with reference to FIG. 10. FIG. 10 is a perspective view schematically showing the droplet discharge device. A difference between the first embodiment and the second embodiment is that carriage replacement devices 19 are provided on both sides of the base 9. Description of the same structure as that of the first embodiment is omitted.

As shown in FIG. 10, a droplet discharge device 81 includes the base 9. At both sides of the base 9 in the X direction, the pair of supports 13a, 13b is provided and a guide member 82 is formed extending in the X direction on the pair of supports 13a, 13b. On a bottom side of the guide member 82, a guide rail 83 extending in the X direction is provided in a projected manner along a whole width of the guide member 82 in the X direction. The guide member 82 and the guide rail 83 are provided protruding from the both sides of the base 9.

The carriage replacement devices 19 are provided on the both sides of the base 9 in the X direction. On an upper part of each of the carriage replacement devices 19 includes the receiving pan 19a, and the lifting mechanism which lifts and lowers the receiving pan 19a provided therein. Then the carriage replacement device 19 separates two carriages from the first carriage 17a to the eighth carriage 17h from the arrangement of the carriage 17 so as to be retractable.

According to the embodiment described above, the following advantageous effects are provided. According to the embodiment, the carriage replacement devices 19 are provided at both sides of the base 9 in a direction that the carriage 17 is arranged. The carriages are replaced by using positions occupied by the carriage replacement devices 19 and a position occupied by the guide rail 83 so as to replace a plurality of carriages from the first carriage 17a to the eighth carriage 17h at a same time. As a result, at least one of the carriages from the first carriage 17a to the eighth carriage 17h can be replaced with a high efficiency.

### Third Embodiment

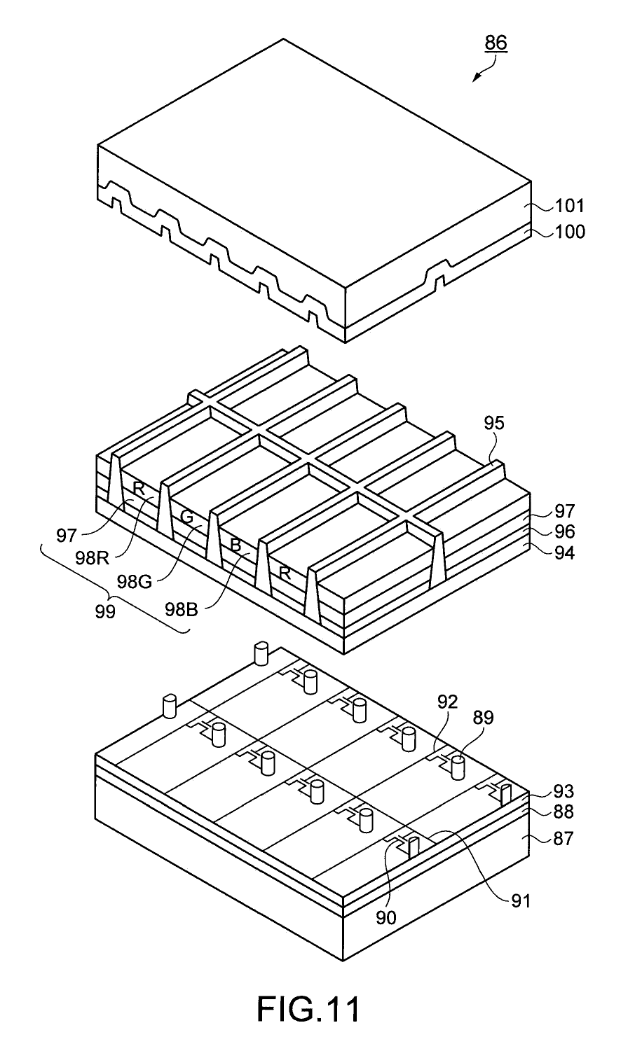

An embodiment of manufacturing an organic Electro Luminescence (EL) device applying the above film forming method will be described with reference to FIG. 11.

An organic EL device will be described as an example of an electro-optical device. FIG. 11 is an exploded perspective view schematically showing a structure of an organic EL device.

As shown in FIG. 11, an organic EL device 86 serving as the electro optical device includes a substrate 87. On an upper side of the substrate, an insulating film 88 is formed. On the insulating film 88, a contact electrode 89 is formed in a matrix pattern. A TFT element 90 serving as a semiconductor which includes switching functions is formed at a position adjacent the contact electrode 89. A drain terminal of the TFT element 90 is coupled to the contact electrode 89.

A scanning line 91 serving as a wiring line and a data line 92 serving as a wiring line are formed in a lattice shape in a manner of surrounding the contact electrode 89 and the TFT element 90. Then, the scanning line 91 is coupled to a gate terminal of the TFT element 90, and the data line 92 is coupled to a source terminal of the TFT element 90.

An element layer 93 which is composed of the contact electrode 89, the TFT element 90, the scanning line 91, the data line 92, and the like is formed. On an upper side of the element layer 93, an insulating film 94 is formed, and on an upper side of the insulating film 94, a partition unit 95 is formed in a lattice shape.

On each bottom of a concave region formed with the partition unit 95, a pixel electrode 96 serving as an electrode is formed so as to be electrically connected to the contact electrode 89. On an upper surface of the pixel electrode 96, a hole transport layer 97 serving as a light emitting element is formed. On upper surface of the hole transport layer 97, light emitting layers 98R, 98G, 98B are formed serving as light emitting elements. Then, a functional layer 99 serving as a light emitting element is formed with the hole transport layer 97 and the light emitting layers 98R, 98G, 98B.

The light emitting layer 98R is composed of an organic light emitting material and the like. Light emitted is from the light emitting layer 98R is red. The light emitting layer 98G serving as the light emitting element is composed of the organic light emitting material and the like. Light emitted from the light emitting layer 98G is green. Similarly, the light emitting layer 98B serving as the light emitting element is composed of the organic light emitting material and the like. Light emitted from the light emitting layer 98B is blue.

On a whole upper surface of the functional layer 99 and the partition unit 95, a negative electrode 100 serving as an electrode which is made of conductive materials having optical transparency is formed. In the embodiment, for example, an indium tin oxide (ITO) is employed as the negative electrode 100.

On an upper surface of the negative electrode 100, a sealing film 101 made of materials having optical transparency is formed so as to prevent the negative electrode 100 and the functional layer 99 from being oxidized with oxygen contained in the air.

When a voltage is applied between the pixel electrode 96 and the negative electrode 100, only positive holes are flown at the hole transport layer 97. The light emitting layers 98R, 98G, 98B have a characteristic of emitting light by energy generated by combining positive holes supplied from the hole transport layer 97 and electrons supplied from the negative electrode 100. The TFT element 90 performs a switching operation, and controls the voltage of the functional layer 99 so as to control a light amount emitted from the light emitting layers 98R, 98G, 98B. Thus, controlling the light amount emitted from the light emitting layers 98R, 98G, 98B allows controlling the light amount with respect to each pixel, and an image can be displayed by blinking pixels.

The pixel electrode 96 is electrically coupled to the drain terminal of the TFT 90. The TFT is turned on for a certain period so that pixel signals supplied from the data line 92 are supplied to each pixel electrode 96 at a predetermined timing. A voltage level of the pixel signals with a predetermined level supplied to the pixel electrode 96 is maintained between the negative electrode 100 and the pixel electrode 96. The light amount emitted from the light emitting layers 98R, 98G, 98B varies according to the voltage level of the pixel signals.

In a step of forming the hole transport layer 97 on a surface of the pixel electrode 96, the applying method of the first embodiment is used. Specifically, a material body of the hole transport layer is discharged to the surface of the pixel electrode 96 with the droplet discharge device 8. Thereafter, the hole transport layer 97 is dried and solidified so as to be formed.

At this time, the carriage replace determination step and the arrangement change step of the first embodiment are conducted. Therefore, each carriages from the first carriage 17a to the eighth carriage 17h has almost the same amount of the material body of the hole transport layer consumed by each droplet discharge head 18.

Furthermore, in a step of forming the light emitting layers 98R, 98G, 98B on a surface of the hole transport layer 97, a drying method of the first embodiment is used. Specifically, the material body of the light emitting layer is discharged and applied to the surface of the hole transport layer 97 with the droplet discharge device 8. Thereafter, the hole transport layer 98 is dried and solidified so as to form the light emitting layers 98R, 98G, 98B.

At this time, the carriage replace determination step and the arrangement change step of the first embodiment are conducted. Therefore, each of the carriages from the carriage 17a to the carriage 17h has almost the same amount of the material body of the hole transport layer consumed by each droplet discharge head 18.

According to the embodiment described above, the following advantageous effects are provided. According to the embodiment, in the steps of manufacturing the functional layer 99 and the light emitting layers 98R, 98G, 98G, the discharge method of the first embodiment is used so that a film thickness of the hole transport layer 97 and the light emitting layers 98R, 98G, 98G are manufactured with a good productivity. Then, the quality of the film thickness is improved so that the hue of light that emits can be better. Furthermore, by improving the quality of the film thickness, a current density within the film is equalized, thereby a life time can be extended.

Here, the embodiments are not limited to the above, and various changes and modification can be made. Modifications will now be described.

Modification 1

In the first embodiment, the consumption calculation step is conducted after the applying step. However, it may be conducted before the applying step. Similarly, the carriage replace determination step and the arrangement change step are also conducted after the applying process. However, they may be conducted before the applying process. The same effects can be obtained.

Modification 2

In the first embodiment, the liquid adding determination step and the liquid adding step are conducted between the arrangement change step and the liquid drain judgment step. However, they may be conducted in different orders. The liquid adding determination step and the liquid adding step may be before the applying step or between the applying step and the consumption calculation step. Furthermore, the liquid adding determination step and the liquid adding step may be between the consumption calculation step and the carriage replace judgment step. They also may be between the liquid drain step and the end determination step. The same effects can be obtained.

Modification 3

In the first embodiment, the liquid drain determination step and the liquid drain step are conducted between the liquid adding step and the end determination step. However, they may be conducted in different orders. The liquid drain determination step and the liquid drain step may be conducted before the applying step or between the applying step and the consumption calculation step. Furthermore, the liquid drain determination step and the liquid drain step may be between the consumption calculation step and the carriage replace determination step. They also may be between the arrangement change step and the liquid adding determination step. The same effects can be obtained.

Modification 4

In the third embodiment, the droplet discharge device 81 of the second embodiment may be used to manufacture the organic EL device. At least one of the carriages from the first carriage 17a to the eighth carriage 17h can be replaced with a high efficiency.

Modification 5

In the first embodiment, the first carriage 17a is lowered to be separated from the arrangement of the carriage 17 with the carriage replacement device 19. However, other methods may be used. For example, a spare guide rail on which the carriage 17 can be moved in the Y direction may be provided on the guide rail 16 so that at least one of the carriages from the first carriage 17a to the eighth carriage 17h can be retracted on the spare guide rail. The arrangement order of the carriage 17 can be changed with the method.

Modification 6

In the first embodiment, the piezoelectric element 48 is used as force means to apply pressure to the cavity 45. However, other methods may be used. For example, the vibration plate 47 is deformed with the coils and the magnets to apply pressure. Meanwhile, a heater wiring line is provided in the cavity 45 and heated so as to apply pressure by evaporating the functional liquid 46 and expanding gas contained in the functional liquid 46. The vibration plate 47 may be deformed with an attraction and a repulsion of static to apply pressure.

Modification 7

In the first embodiment, the color filer 1 is formed in a strip manner that the color elements 3 of the same color arranged in a straight line manner. However, the color elements 3 may be arranged in a delta arrangement, a mosaic arrangement, and the like.

Modification 8

In the first embodiment, the color filter 1 includes three colors of the color elements 3. However, it is not limited to three colors, and two colors or more than four colors can be applied.

Modification 10

In the first embodiment, the program software 65 that follows the operation procedures is stored in the memory 55 of the control device 55 so as to control the droplet discharge device 8 with the program. However, it is not limited to this, but also the droplet discharge device 8 can be controlled with a control device consists of an electric circuit. It is only necessary to control peripheral devices by following the procedures.

Modification 10

In the first embodiment, a single carriage replacement device 19 is provided. However, a plurality of carriage replacement devices 19 may be provided. Then, a plurality of the carriage from the first carriage 17a to the eighth carriage 17h may be replaced in a same time with the plurality of the carriage replacement devices 19. At least one of the carriages from the first carriage 17a to the eighth carriage 17h can be replaced with a higher efficiency.

Modification 11

In the second embodiment, two carriage replacement devices 19 are provided with the base 9 therebetween. However, more than three carriage replacement devices 19 may be provided. In addition, the plurality of the carriages from the first carriage 17a to the eighth carriage 17h may be replaced in the same time with the plurality of the carriage replacement devices 19. At least one of the carriages from the first carriage 17a to the eighth carriage 17h can be replaced with a higher efficiency.

Modification 12

In the first embodiment, a position of the first carriage 17a is replaced with a position of the eighth carriage 17h. Other than changing the arrangement order by replacing positions of two carriages from the first carriage 17a to the eighth carriage 17h, only one of the carriages from the carriage 17a to the eighth carriage 17h may be moved. For example, in accordance with a distribution of the functional liquid 46, the position of the first carriage 17a may be replaced adjacent to the position of the eighth carriage 17h. In addition, positions of more than three carriages from the first carriage 17a to the eighth carriage 17h are relatively replaced so as to change the arrangement order of the carriage 17.

Modification 13

In the first embodiment, at least one of the carriages from the first carriage 17a to the eighth carriage 17h is moved in the Z direction and retracted with the carriage replacement device 19. A carriage replacement device that retracts the carriage from the first carriage 17a to the eighth 17h in the Y direction may be provided. The carriage from the first carriage 17a to the eighth carriage 17h 17 may be retracted with a method that moves the carriage 17 easily.

Modification 14

In the first embodiment, at least one of the carriages from the first carriage 17a to the eighth carriage 17h is retracted with the carriage replacement device 19 and moved along the guide rail 16 so as to change the arrangement order. An arrangement changing device that changes the arrangement of the carriage 17 may be provided. Then, after the carriage 17 is moved to the arrangement changing device and changed the arrangement, the carriage 17 may be moved to the guide rail 16. The method provides a similar advantageous effect.

The entire disclosure of Japanese Patent Application No. 2008-15880, filed Jan. 28, 2008 is expressly incorporated by reference herein.

What is claimed is:

1. A droplet discharge device, comprising:
a droplet discharge head;
a plurality of carriages that have the droplet discharge head and are arranged in an array; and
an arrangement changing unit changing an order of the plurality of carriages in the array, wherein the droplet discharge device discharges a liquid body to a workpiece while the droplet discharge device scans relatively to the workpiece.

2. The droplet discharge device according to claim 1 further comprising an arrangement order calculation unit which provides an instruction to the arrangement changing unit to replace at least one of the carriages, wherein the arrangement order calculation unit calculates consumption of the liquid body of each carriage so as to provide the instruction to change an order of the carriage of which consumption is different from a predetermined amount in the array.

3. The droplet discharge device according to claim 1, wherein the arrangement changing unit includes a retracted position of the carriage, wherein at least one of the carriages is retracted at the retracted position while non-retracted carriages are moved in the array direction to change the order of the plurality of the carriages.

4. The droplet discharge device according to claim 1, wherein the arrangement changing unit includes a plurality of arrangement changing units, the arrangement changing units being respectively provided at positions to sandwich the workpiece provided in the array direction.

5. The droplet discharge device according to claim 1, wherein the retracted position is positioned in a gravity acceleration direction so as to face a place in which the carriages are arranged.

6. A method for discharging a liquid body to a workpiece with a droplet discharge head provided to a plurality of carriages, the method comprising:
calculating consumption of the liquid body of each of the plurality of carriages; and
determining to change an order of the carriage of which consumption is different from a predetermined amount in the array.

7. A method for manufacturing a color filter in which a liquid body is discharged to a substrate with a droplet discharge head provided to a plurality of carriages so as to form a film, the method comprising;
calculating consumption of the liquid body of each of the plurality of carriages and determining to change an order of the carriage of which consumption is different from a predetermined amount; and
changing the order of the carriage in the array, wherein the liquid body includes a color filter formation material.

8. A method for manufacturing an organic electro luminescent (EL) device in which a liquid body is discharged to a substrate with a droplet discharge head provided to a plurality of carriages so as to form a film, the method comprising;
calculating consumption of the liquid body of each of the plurality of carriages and determining to change an order of the carriage of which consumption is different from a predetermined amount; and
changing the order of the carriage in the array, wherein the liquid body includes a light emitting element forming material.
